(19) United States
(12) Patent Application Publication
(10) Pub. No.: US 2018/0229153 A1
(43) Pub. Date: Aug. 16, 2018

(54) Method Of Electrotreating Tailings To Create Geotechnical Structures

(71) Applicant: Electrokinetic Solutions Incorporated, Toronto (CA)

(72) Inventors: Bruce S. Beattie, Vista, CA (US); Paul Garcia, Temecula, CA (US); Doug Kimzey, Knoxville, TN (US); Ben HARRIS, Fallbrook, CA (US); Robert C. PARROTT, Knoxville, TN (US); James MICAK, Aurora, Ontario (CA); Robert FALERO, Corona, CA (US)

(21) Appl. No.: 15/514,295

(22) PCT Filed: Sep. 25, 2015
(86) PCT No.: PCT/CA2015/000505

§ 371 Date: Mar. 24, 2017

(30) Foreign Application Priority Data
Sep. 26, 2014 (CA) 2865400

(51) Int. Cl. B01D 17/06; B03C 5/02; C10G 1/04; C02F 1/461

(52) U.S. Cl. CPC B01D 17/06; B03C 5/026; C10G 1/04; C02F 2101/20; C02F 2001/46157; C02F 2001/46171; C02F 1/46109

(57) ABSTRACT

A method of electro treating tailings in a containment structure to cause a separation of at least some water from said tailings and a consolidation and compaction of at least some solid particles is shown. The method includes placing a plurality of first electrodes in the tailings to be treated generally along one side of a predetermined volume and placing a plurality of second electrodes in the tailings to be treated generally along an opposite side of said volume to the plurality of first electrodes, said first and second electrodes being spaced apart by a predetermined distance. The next step is applying a treatment current across said distance between said spaced first and second electrodes to create an electrical field which causes solids to consolidate at one of said plurality of first and second electrodes; and creating a geotechnical structure within said volume comprised of dewatered solids consolidated from said tailings around one of said electrodes. The geotechnical structure may be a layer at the bottom of the containment structure, along a side of the containment structure or across the top of a containment structure.

### FIELD OF THE INVENTION

This invention relates generally to the field of treating tailings especially wet tailings of the sort that might contain some clay particles, some water and some other contaminants such as hydrocarbons, heavy metals or the like. Most particularly this invention relates to treating persistent tailings that are accumulated as waste by-products from mining or other industrial processes. An example of a process which creates such tailings is for example, the extraction of hydrocarbons from oil sands with hot water such as is used in the Clarke process.

### BACKGROUND OF THE INVENTION

Oil or tar sands are a source of hydrocarbons, which is commonly called bitumen, which can be recovered, and then reformed into a synthetic crude or Syncrude™. At present some of such hydrocarbons are recovered through a process known as surface mining. To obtain Syncrude™, the hydrocarbons must be first separated from the natural base or matrix in which it is found. This matrix includes sands, clays, silts, minerals and other materials, such as heavy metals. Typically the matrix is lifted by large shovels into dump trucks and trucked to a separation facility. The most common separation step used on surface mined oil sands is the hot water separation process which uses hot water to separate out the hydrocarbons from the sand and clay matrix. However, the separation is not perfect and a liquid waste is produced as a by-product which may include small amounts of hydrocarbons, heavy metals and other waste materials, but is mostly a stable colloidal mixture of water and clay, sand and other materials. One form of this waste liquid is called Mature Fine Tailings (MFT) and is collected in onsite reservoirs called tailings ponds. Unfortunately, MFT is a very persistent material that is not easy to treat or to dry out.

Oil extraction has been carried out for many years on the vast reserves of oil that exists in Alberta, Canada. It is estimated that 750,000,000 m³ of MFT have been produced. Some estimates show that 550 km² of land has been disturbed by surface mining, yet only 267 ha (less than 0.5%) has received certification as being reclaimed. Even this small area was not mined, nor used for associated processing operations, but was only used for the storage of overburden.

The MFT ponds present three environmental and economic issues: water and pollution management, sterilization of potentially productive ore located below the ponds and delays in reclamation of the water in the tailings itself. Although concentrations vary, MFT can typically comprise 50 to 70% water. This high water content forms, in combination with the naturally occurring clays, a thixotropic liquid. This liquid is quite stable and persistent and has been historically collected in large holding ponds. Very little has been done to treat the MFT that has been created and so it continues to build up in ever larger holding ponds. As development of the oil sands accelerates and more and more production is brought on line, more and more MFT will be produced.

What is desired is a way to deal with the MFT that has been and will be generated, to permit land reclamation, a way to release captured water in an environmentally responsible way and to provide access to the productive ore located beneath such ponds. Further the presence of ever larger amounts of wastes to contain presents storage problems and concerns about leaching and the like of the liquids from existing storage facilities either into the ground water or into surface runoff such as streams and the like. What is desired is a way to stabilize the MFT to remove the water and to increase its load bearing capacity so it can be buried and the land reclaimed and remediated above it. Recently the AER (Alberta Energy Regulator) has indicated that there will be deadlines imposed to resolve the tailings issue.

MFT represent a mixture of days (illite, montmorillonite and kaolinite), water and residual bitumen resulting from the processing of oil sands. In some cases MFT may also be undergoing intrinsic biodegradation. The biodegradation process may create a frothy mixture, further compounding the difficulty in consolidating this material. These days, most particularly, sodium montmorillonite found in MFT are expansive; i.e., volumetric changes of as much as 30% can occur between wetting and drying. It is estimated that between 40 and 200 years are required for these days to sufficiently consolidate to allow for reclamation of tailings ponds, if left to their own devices. Such delays will result in unacceptably large volumes of MFT, and protracted periods of time before reclamation can take place unless a way to effect disposal and reclamation is found.

It is known that the application of an electrical field to a dielectric material results in certain electro-kinetic phenomena, including electro-osmosis, the movement of water from an anode to a cathode; electrophoresis, the movement of ions in the water to oppositely charged electrodes and electrostriction, a result of the application of an electrical field that results in mechanical work which deforms the dielectric material. Electro-osmosis has been used to dewater solid or consolidated day soils for construction projects to improve load bearing capacity. Electrophoresis has been used in many industries, such as the pharmaceutical industry and ceramics industry to produce high grade separations. Electrostriction has been used on a small scale to create high density ceramics. In an electrical resistance heating treatment at Fargo, N. Dak. (Smith et al., 2006)^{a}, where the applied electric field ranged between 0.46 to 0.8 volt/cm, an electro osmotic phenomenon was observed with AC current. Examples of applications of electrical fields in various circumstances can be found in the following prior patents. ^{a}Smith, G. J., J. von Hatten, and C. Thomas (2006) Monitoring Soil Consolidation during Electrical Resistivity Heating. Proceedings of the Fifth International Conference on Remediation of Chlorinated and Recalcitrant Compounds. May 22-25, 2006, Monterey, Calif.,
U.S. Pat. No. 3,962,069
U.S. Pat. No. 4,107,026
U.S. Pat. No. 4,110,189
U.S. Pat. No. 4,170,529
U.S. Pat. No. 4,282,103
U.S. Pat. No. 4,501,648
U.S. Pat. No. 4,960,524
U.S. Pat. No. 5,171,409
U.S. Pat. No. 6,596,142

The application of electrical current to treat oil sands tailings has also been tried, as shown in U.S. Pat. No. 4,501,648. However, this teaches a small device with a tracked moving immersed electrode onto which is deposited clay solids. The electrode is moved out of contact with the liquid and then the solids are scraped off the electrode. A chemical pre-treatment step is required to achieve the desired deposition rate on the immersed electrode. While interesting, this invention is too small scale and expensive to be practical for MFT treatment and requires a chemical pre-treatment step which adds to the cost. What is desired is a better way to deal with vast volumes of MFT that now exist and will continue to be created by ongoing operations.

Our own prior patent Canadian Patent No. 2,736,675 teaches using an electro treating process to encourage the water to separate from the clay and to therefore speed up the reclamation process. However what is required is an apparatus and a process whereby the electrical field can be applied in an efficient and sensible manner to economically treat the liquid wastes such as MFT to recover and reuse the trapped water, to free up storage capacity and generally mitigate harmful environmental effects.

### SUMMARY OF THE INVENTION

The present invention provides a configuration of electrodes and a staged treatment plan whereby the MFT may be treated in an economical and efficient way. In particular the present invention teaches that rather than using electrodes spread out to form a regularly spaced treatment grid to evenly treat large areas or volumes of tailings as in the prior art, the electrodes may be placed in the MFT to be treated generally towards the edges of a predetermined three dimensional space or volume to create an electrical field to generate a geotechnical structure within the volume having one or more of a desired width, length, thickness, position, porosity and strength. In one embodiment the geotechnical structure can be made by positioning the electrodes to create an electrical field in which the current is generally parallel to the direction of gravitation forces. Provided the current is passed between the electrodes in the correct direction the use of horizontal electrodes may encourage the electromotive forces to be acting on the solid particles in the same direction as gravity to enhance the consolidation of the solids into the geotechnical structure. In another embodiment the electromotive forces may be acting in a direction opposite to gravity to create a geotechnical structure in the form of, for example, a consolidated skin or top layer on a tailings pond. In another embodiment the electromotive forces might be generally orthogonal to the direction of gravity to create a geotechnical structure in the nature of a side wall for a containment structure to reinforce a side slope of a containment pond. In any case, the use of disposable electrodes may allow the electrodes to be abandoned, in the consolidated solids which form the geotechnical structure, and to thereby avoid the cost of recovering and reclaiming the electrodes. As well the abandoned electrodes may add structural integrity as a form of reinforcing of the geotechnical structure created by the consolidated solids. In another embodiment the present invention may allow consolidation to create geotechnical structures consisting of a number of layers, with one layer building upon the next with the simple expedient of placing a further electrode spaced from the old electrode pair which then becomes part of a new electrode pair to generate a new consolidating layer. In some cases these layers may be consolidated sufficiently to be impervious, for example to act as a tailings pond lining. In other cases the layers may be required to have a specific bearing strength to allow for further non electro treating consolidation.

Thus the present invention comprehends that various geotechnical structures may be formed including bottom layers, top layers and side wall structures according to the present invention.

According to a preferred aspect of the invention therefore there may be provided a method of electro treating tailings to cause a separation of at least some water from said tailings and a consolidation and compaction of at least some solid particles, said method comprising:
a. Placing a plurality of first electrodes in said tailings to be treated generally along one side of a predetermined volume;
b. Placing a plurality of second electrodes in said tailings to be treated generally along an opposite side of said volume to said plurality of first electrodes, said first and second electrodes being spaced apart by a predetermined distance;
c. Applying a treatment current across said distance between said spaced first and second electrodes to create an electrical field which causes solids to consolidate at one of said plurality of first and second electrodes; and
d. Creating a geotechnical structure within said volume comprised of dewatered solids consolidated from said tailings around one of said electrodes.

According to another aspect the present invention provides a method of electro treating oil sands tailings to cause a separation of at least some water from said tailings and a consolidation and compaction of the remaining solid material, said method comprising:
a. Placing a plurality of first generally horizontal electrodes in said tailings to be treated;
b. Placing a plurality of second generally horizontal electrodes in said tailings to be treated in a position either generally above or generally below said first generally horizontal electrode, said electrodes being spaced apart by a predetermined distance;
c. Applying a treatment current across said distance between said spaced electrodes in a direction to cause a lower electrode of said electrode pair to be an anode and a higher of said electrode pair to be a cathode;
Wherein said electrical current urges solids to migrate in the same direction as gravity while water will migrate toward the cathode, allowing water to collect at the top of the treatment area.

### BRIEF DESCRIPTION OF THE DRAWINGS

Reference will now be made by way of example only to preferred embodiments of the invention by reference to the following drawings in which:

FIG. 1 shows a side view of a tailings pond with a pair of horizontal electrodes connected to a power source according to one embodiment of the present invention;

FIG. 2 shows the tailings pond of FIG. 1 after being treated by an electrical field to cause a separation of mostly solid waste below and mostly water above;

FIG. 3 shows the tailings pond of FIG. 2 with the water removed, a further lift of tailings loaded into the pond and a further electrode being placed above the existing electrodes and connected to the power source;

FIG. 4 shows an end view of the tailings pond of FIG. 1 showing a possible spacing arrangement of the horizontal electrodes throughout the pond;

FIG. 5 shows a filled pond where numerous lifts have been applied and the water has been substantially removed;

FIG. 6 shows a detailed view of the particles moving downwardly under the influence of both gravity and the electro kinetic forces and displacing the water upwardly; and

FIG. 7 shows an alternate spacing arrangement for the horizontal electrodes.

FIG. 8 shows a part of an electrode frame assembly, including both horizontal electrodes and vertical spacing electrodes according to a further embodiment;

FIG. 9 shows a more comprehensive frame assembly creating a geotechnical structure according to a further aspect of the invention;

FIG. 10 shows the frame of FIG. 9 in place in a tailings pond to be treated;

FIG. 11 shows a geotechnical structure being formed during the electro treatment phase at the top of the tailings pond according to one embodiment;

FIG. 12 shows an overburden loading step onto the geotechnical structure formed as shown in FIG. 11;

FIG. 13 shows the positioning of electrodes to treat a volume adjacent to a side of a containment pond, for example to reinforce the same by forming a side geotechnical structure; and

FIG. 14 shows the geotechnical structure formed at a side of a tailings pond according to electrode positioning of FIG. 13.

### DETAILED DESCRIPTION OF THE PREFERRED EMBODIMENTS

FIG. 1 shows an embodiment of the present invention in the context of a side view of a containment structure 20 for a tailings pond 22 having inclined side walls 24, 26 and a bottom 28. As shown the containment structure 20 may be simply dug out of the ground, but it will be appreciated that the present invention comprehends all different types of containment structures 20 including ones that might be lined with an impermeable material, such as clay, and ones that are made out of a structural material such as concrete or the like. Further the containment structure 20 may be dug into the ground as shown or may be left standing proud of the ground surface. All that is required is that the containment structure 20 be sufficiently watertight so that the tailings which are to be contained can be so contained.

In this description the term geotechnical structure means a structure made in situ from fines or clay solids or other dewatered solids extracted from a tailings pond. In this sense a structure is a deposit of solids which is organized according to a containment or treatment plan and may comprise generally horizontal, inclined or vertical structures. In particular such a geotechnical structure may preferably have been consolidated by an electro treat, such as by means of an AC current with a DC offset as described in one or more of our prior patents including Canadian Patent No. 2,736,675, Canadian Patent Application No. 2,758,872 published on Oct. 7, 2012 and Canadian Patent Application No. 2,782,949 published on Jan. 9, 2014. Although other types of consolidating forces can be used to create consolidated soils from tailings it is believed that the AC current with a DC off set is able to provide good results at a reasonable cost. As well, the use of such an electro treat allows for the creation of a geotechnical structure around the electrode, which in turn means that the electrodes may be placed in a position to create a geotechnical structure of a predetermined size, shape and location, and may be developed to a desired strength based on the treatment time and the strength of the electrical field. The present invention comprehends that the treatment time and intensity can be set for a specific strength and function desired from the design purpose of the geotechnical structure as explained in more detail below.

FIG. 1 also shows a level of tailings fluid 21 in the containment structure 20 which may be any type of tailings of the sort that might be amenable to being treated with an electro-treating process such as is described in this specification. It is believed that oil sand tailings known as MFT or Mixed Fine Tailings are a type of tailings that are most suitable for the present invention, as well as certain mine tailings, flay ash tailings and other types of tailings. The present invention comprehends being able to treat a tailings mixture containing various types of clays, water and other contaminants and may be applied to many different types of tailings. All that is required is that the tailings be of the sort that responds favourable to an electro treat process, such as an AC treat with a DC offset as previously described.

Also shown in FIG. 1 is an electrical control apparatus 34 electrical conductors 36, 38 and a pair of horizontal electrodes 40, 42. As shown the first electrode may be placed adjacent to the bottom of the tailings pond and the second electrode maybe placed generally parallel to the first electrode, but somewhat above the first electrode. Spacing between electrodes is an important design consideration. Placing the electrodes close together will result in a stronger electric field and a faster and more consistent treatment of a smaller treatment volume. Placing the electrodes further apart increases the volume treated and reduces the cost of equipment but increases the treatment time and can reduce the consistency of treatment. The actual spacing applied will be based on the overall goals of the treatment system. However reasonable results can be had with a spacing of 0.5 to 25 metres, and good results can be had with a spacing of 3 to 20 metres. The most preferred spacing is about 5 to 15 metres.

In terms of field intensity the intensity of the AC treatment can be applied in a range of 0.5 V/cm to 1.5 V/cm and most preferable is in a range of 0.75 V/cm to 1.25 V/cm. AC treatment is preferable at a low frequency (10 Hz or lower). The DC offset can also be applied in a range amount of 0.25 V/cm to 0.75 V/cm. The present invention comprehends a range of treatment intensities the specifics of which will depend upon the properties of the tailings to be treated, including the water content and the nature of the solids within the tailings. As well the treatment duration can be varied to allow a geotechnical structure of a specific size and strength to be created.

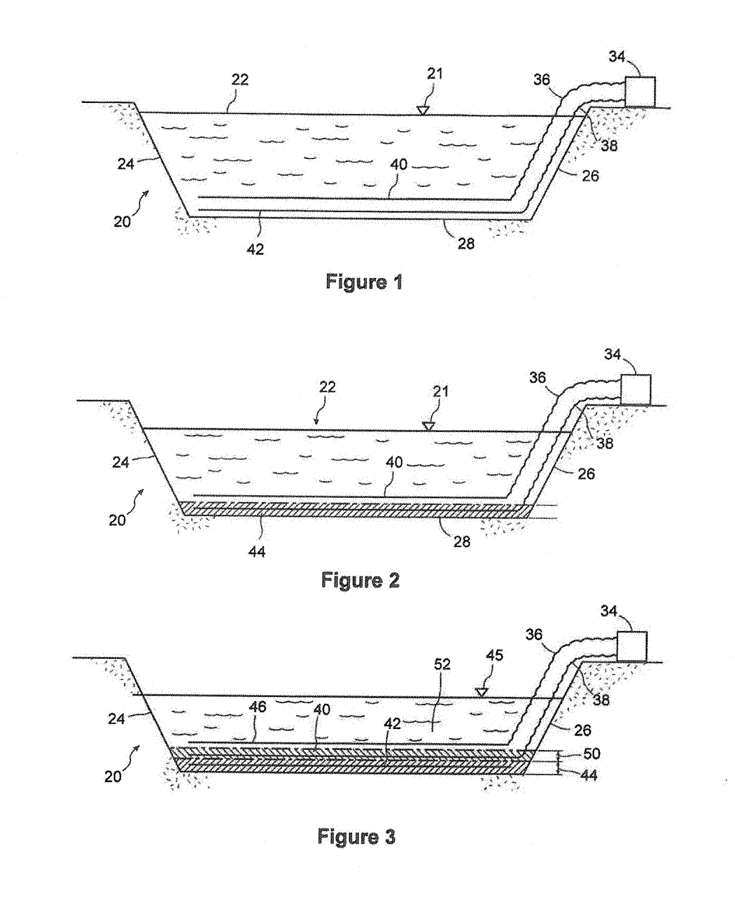

According to one aspect of the present invention if the horizontal electrodes are lined up one above the other then they will create an electric field between them that is essentially parallel to the gravitation field. FIG. 2 shows the containment pond 20 of FIG. 1 after a first stage of the electro treatment according to the present invention. In this case the first electrode 42, which is the lower electrode, acts as the anode and the second electrode 40 or the higher one acts as the cathode. By configuring the electrodes this way the gravitational forces are aligned with the electromotive forces, encouraging a good separation of water upwardly from the solid clay particles which move downwardly. According to this aspect of the invention the clay particles may be encouraged to settle to the bottom of the pond and consolidate around the electrode 40, while the water is encouraged to be expressed at the top of the pond toward the electrode 42 where it can be removed. In this way a geotechnical structure comprising a denser liner layer 44 can be built up on the bottom of the pond adjacent to the horizontal electrode. As can be appreciated, aside from reducing the volume of the pond through solids consolidation and water removal, a lining layer, if consolidated sufficiently through treatment time and intensity may provide additional security against the escape of the contents of the pond into the adjacent groundwater.

The denser layer 44 at the bottom of the containment structure 20 may be one form of a geotechnical structure formed according to the present invention. For example, depending upon the treatment time the solid dewatered layer 44 may be consolidated to a degree whereby the dewatered layer is essentially impervious to water seepage.

FIG. 3 shows the next step in the treatment process according to one embodiment. In this step the first electrode 42 is disposable and has been abandoned and has been disconnected from the source of electrical power. As well, a further electrode 46 has been added generally above the second electrode 40. The electrical connections have been modified so that now the second electrode acts as the anode and the further electrode 46 above acts as a cathode. Once again the electrical current is applied creating an electrical field that encourages the clay particles to sink to the bottom and the water to be expressed off the top. Over time a second layer 50 is consolidated above the first layer as shown with a further layer of water 52 lying on top of the second layer. This second layer may be used to reinforce the geotechnical structural lining the containment pond 20

The present invention comprehends that the expressed water 52 may be removed from the containment structure 20 and treated to make it suitable for re-use or for disposal into the environment. Assuming that no fresh waste has been added the tailings pond level may have subsided due to the removal of water and the consolidation of solids as shown as level 45 which is lower than level 21. The present invention may be used to free the water from the tailings mixture and enable the water to be removed and treated and reused or disposed of. Once the water is expressed from the thixotropic material it can be processed in conventional water purification processes and ideally recycled back into the main hot water extraction process again. It will be appreciated that the present invention comprehends repeating the steps outlined in FIGS. 1 to 3 as many times as may be needed to create a consolidated structure within the containment pond. In this sense the degree of consolidation desired may be to create a geotechnical structure which consists of material with an average solids content of at least 50% solids. Once the structure is formed with material with that level of solids content, it should be able to support a surcharge to encourage further consolidation underneath the structure. After the entire deposit has consolidated to support reclamation, it can be covered with clean fill and the land reclaimed.

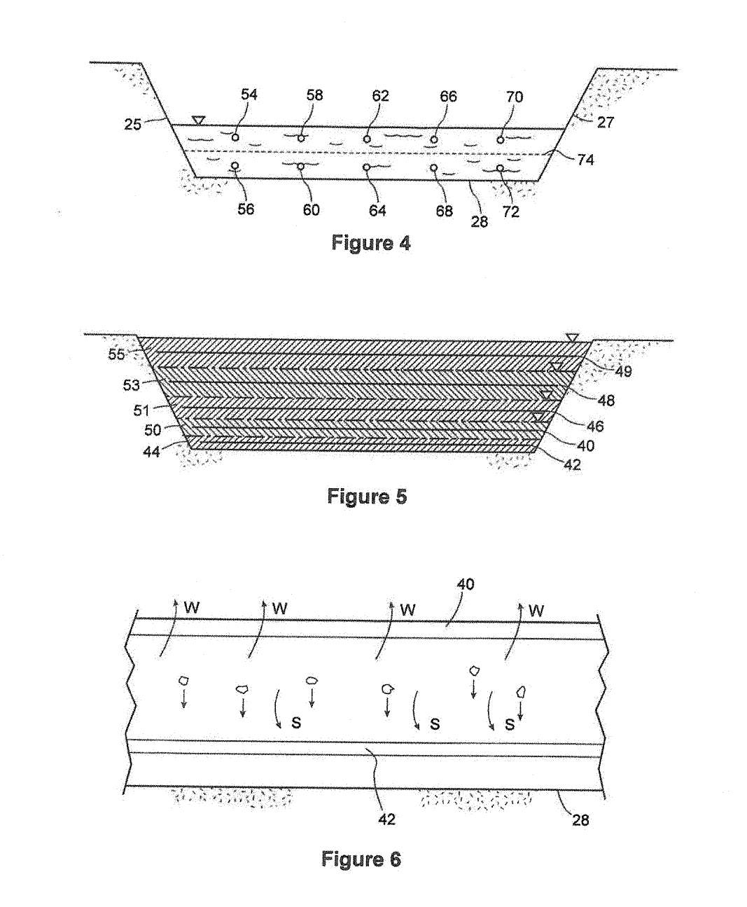

FIG. 4 is an end view of the containment pond of FIGS. 1 to 3. In this view the ends 25 and 27 are visible as well as the bottom 28. As can be seen there are multiple electrode pairs 54, 56, 58, 60, 62, 64, 66, 68, 70 and 72 each of which is used to create a geotechnical structure in the form of a consolidated lining layer. By using a plurality of horizontal pairs as shown a geotechnical structure or layer shown in dotted outline 74 of a greater overall area may be created.

FIG. 5 shows a view from the side after the consolidation is complete. As shown the electrodes 40, 42, 44, 46, 48 and 49 are left behind within the layers 44, 50, 51, 53 and 55 and the top of each layer is shown. The consolidated layers have had a substantial amount of the starting 50% to 70% water removed, which has greatly shrunk the total volume of the tailings in the pond. One aspect of the present invention therefore is that as the water is expressed and removed more space is created for further tailings to be added to the containment structure, if desired.

FIG. 6 is a close up view of the beginning of the formation of a geotechnical structure in a volume according to the above noted aspect of the present invention. In this view the water molecules W are being driven up, in the direction of arrows and the solids, S such as the clay particles are being driven down by the electrical field created between the electrodes, as shown by the arrows. As shown, in this embodiment the solid particles are encouraged to move in the same direction as they are being otherwise urged by gravity. Thus gravity is further encouraging the dewatering step and the formation of a geotechnical structure at the bottom of the tailings pond. Also shown are the anode 40 and the cathode 42 for example.

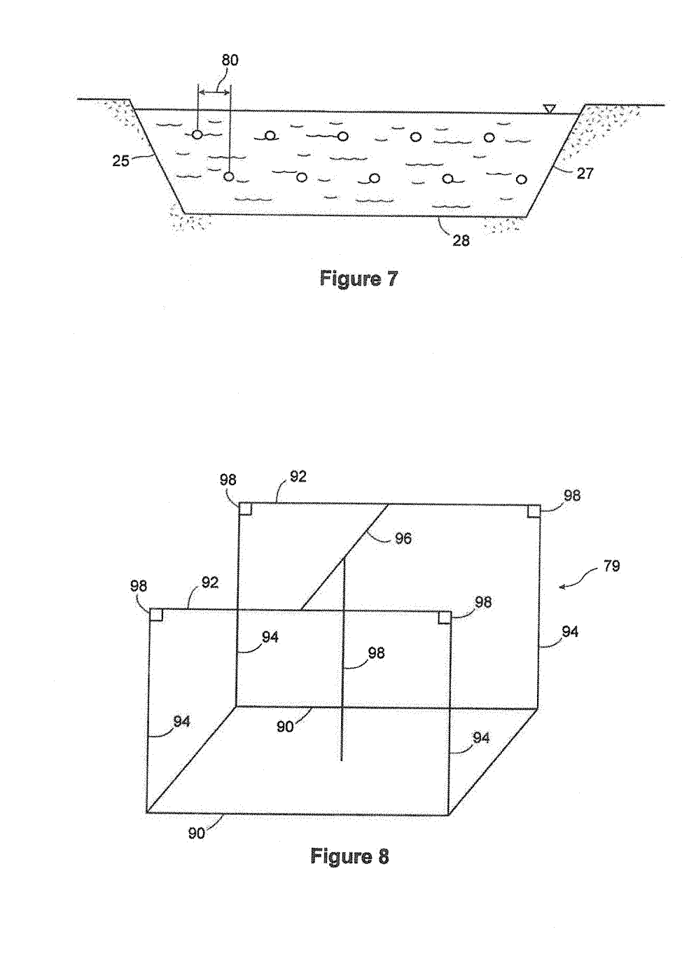

FIG. 7 is an alternate embodiment of the present invention in which the upper horizontal electrodes or cathodes may be laterally offset by a distance 80 with respect to the lower electrodes or anodes. Providing the spacing is adequate between the electrodes the offset spacing may encourage a better sweeping of the tailings of solids and a more even consolidation of the layer into a geotechnical structure around the cathode. The present invention comprehends various horizontal electrode configurations from being directly one above the other to being offset at various amounts. The position of the electrodes can vary depending upon the strength of the electrical current and the electrical properties of the tailings, but all that is required is to be able to establish a current flowing through the tailings in a manner that is able to drive the water towards the cathode and drive the dewatered solids towards the anode.

In another embodiment of the present invention the horizontal electrodes are used to create an electrical field which directs the solids in a direction other than in the direction of gravity. In this case the present invention comprehends that a geotechnical structure may be formed by a local consolidation of the solids adjacent to the anodes. As such the present invention comprehends positioning the anodes in a location where the geotechnical structure is to be positioned.

By way of example, FIG. 8 shows a frame electrode 79 set in which the paired horizontal electrodes are shown with the anode as 90 and the cathode as 92. Vertical spacers 94 are also shown, as well as a horizontal spacer 96 with a dangling leg 98. At the corners a dielectric joint 98 may be used. The elements 92, 96 and 98 are the anode in this embodiment and the elements 90, 94 are the cathode. The vertical electrodes may allow the current field to be more evenly distributed within the frame and the anode attracts solids and the cathode attracts water as in the prior examples.

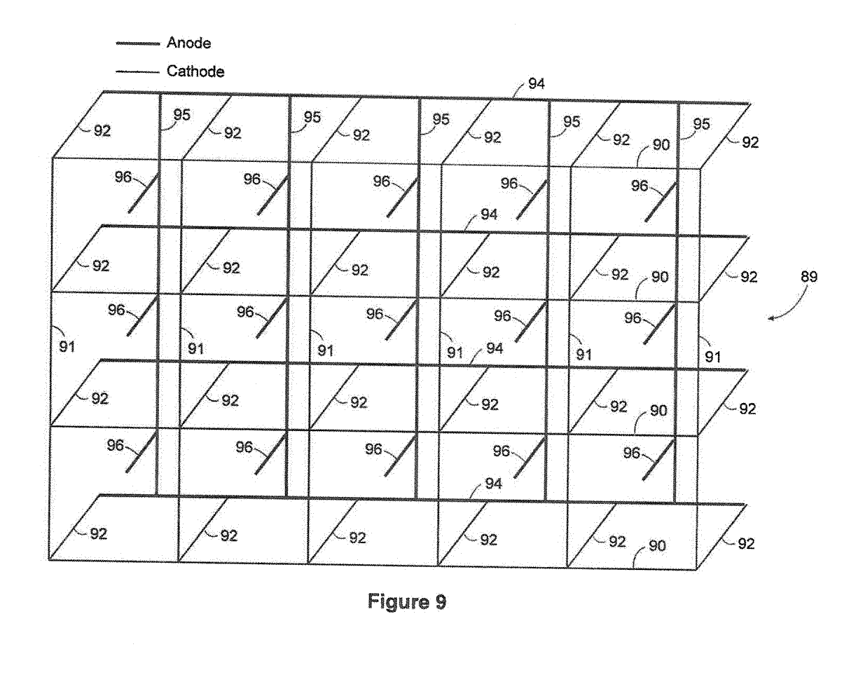

FIG. 9 shows a frame electrode 89 similar to the frame electrode 79, but on a larger scale. The anode elements include horizontal electrodes 90, horizontal spacers 91 and vertical spacer electrodes 92, and the cathode elements include horizontal electrodes 94, horizontal spacers 95 and dangling electrodes 96. Again dielectric joiners can be used to prevent short circuiting where the cathode and the anode are connected. This configuration is believed to provide a reasonably uniform electrical field within the frame volume.

In this arrangement the solids may be encouraged by the electro-treating process to consolidate around the anode part of the frame and as a result may provide a geotechnical structure in any desired location within the tailings pond. In one embodiment a layer at a top of the tailings pond may be created. This is because the frame electrode can be supported in place for example towards a top of the tailings fluid. It may be supported by floats, or other anchoring elements secured to the shore or with supports from the bottom of the pond as the case may be. In some cases the solids collecting around the vertical anode may act as structural elements, in the nature of columns. However this is dependent on the intensity and duration of treatment provided and is not considered an essential element.

In this aspect of the invention by positioning the frame element at or near the top of the pond, a geotechnical structure in the form of a surface load bearing layer may be formed which layer may facilitate further consolidation of the tailings below through more conventional means. Preferably the top layer is consolidated enough to be impervious to the tailings and load bearing.

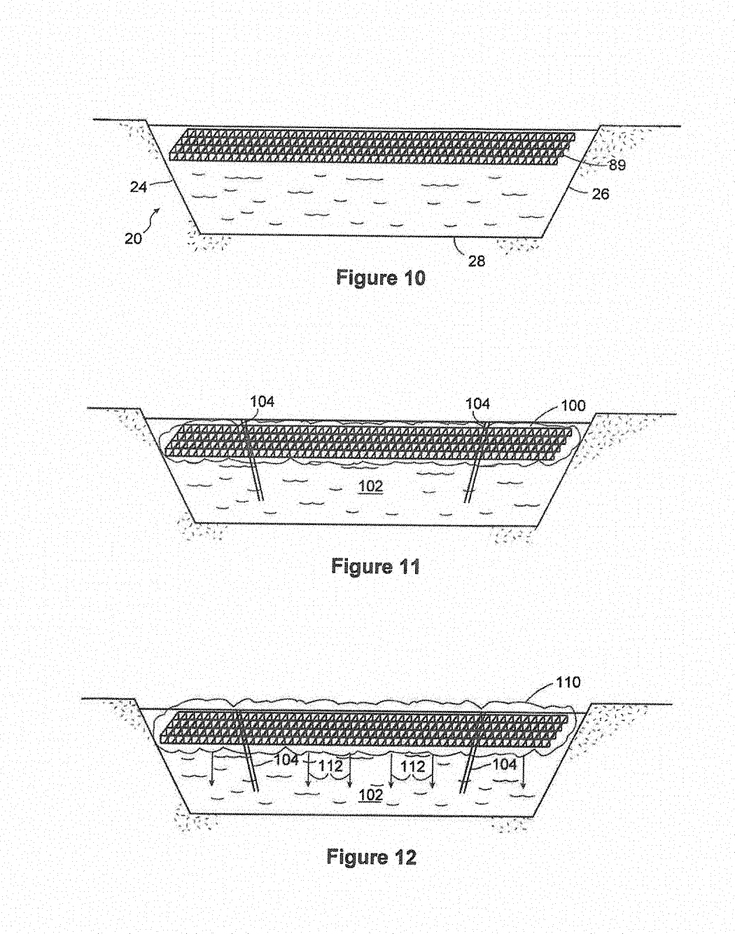

FIG. 10 shows the frame electrode 89 positioned across a top of the tailings pond 20. In this case it is shown supported at either end on the inclined slopes 24 and 26. As the electrical treatment is applied solids may consolidate around the frame 89 as shown as 100 in FIG. 11. After enough treatment time the solids will form a geotechnical structure and may be a load bearing structure. Once this has been achieved, the top layer 100 will become a weight pressing down on the more watery liquids 102 below which weight can be used to encourage water expression and further consolidation through the use of convention wick sand or other types of drains 104. This further consolidation may be passive, in the sense that it requires no additional electrical energy or electro-treating. After the top layer 100 has been consolidated sufficiently to be a load bearing geotechnical structure, then a surcharge load 110 may be added on top of that layer 100 as shown in FIG. 12 to further compress the tailings located below the top layer in the direction of arrows 112. This surcharge loading may also be accompanied by wick drains or the like to allow water to be expressed from the tailings pond under the compressive loading. Removing the water from the watery layer below will further facilitate the compression so as to eventually leave a fully consolidated layer beneath the original electro-treated layer or geotechnical structure. An advantage of this approach is the reduced cost as there is no need for further electricity to be used during the secondary or passive consolidation step taking place under the geotechnical layer and encouraged by the further loading. As will be understood the present invention comprehends that the further loading is optional and in some cases the geotechnical structure may not have enough load bearing capacity to be able to add the surcharge load. The load bearing capacity is related to the duration and intensity of the electro treatment and in some cases it may not be economic to apply enough electrical treat to achieve a truly load bearing geotechnical structure.

In the frame electrode arrangements as shown in FIG. 8 through 12 the cathode can be made with both horizontal and vertical electrodes. The vertical electrodes will help consolidate the layer to a certain depth and the horizontal electrodes will help consolidate the tailings over a certain area. Thus the electrode cage as shown may be used to create both an area and a thickness of consolidated solids. Where the electrodes are made from a sufficiently robust and rigid material, such as used oil well tubing or the like the electrode cage can also act as stabilization or reinforcing structure within the geotechnical structure made by the electro-treating process.

In a further embodiment of the present invention the electrodes can be positioned to establish a geotechnical structure where it is most desired. For example, in certain situations the containment pond may have side walls which are simple earth berms or earth dikes. In cases where too much water is placed within the berms or dikes, or where there has been erosion of the like of the dike wall this in turn can threaten to spill the contents of the containment structure into the surrounding land. In some cases there may be erosion from the inside as the watery tailings act on the inside wall of the earth dike or berm. In such cases the only strategy may be to try to add wall thickness to the outside of the dike, but this may also be constrained by the presence of geological features such as river banks, streams or the like. Often the tailings ponds are an accumulation of materials which are harmful to the environment and thus are not to be released into the surrounding lands and waterways under any circumstances, let alone in a catastrophic wave as a result of the dike failure. What is desired is a way to rebuild the inside wall of the dike structure.

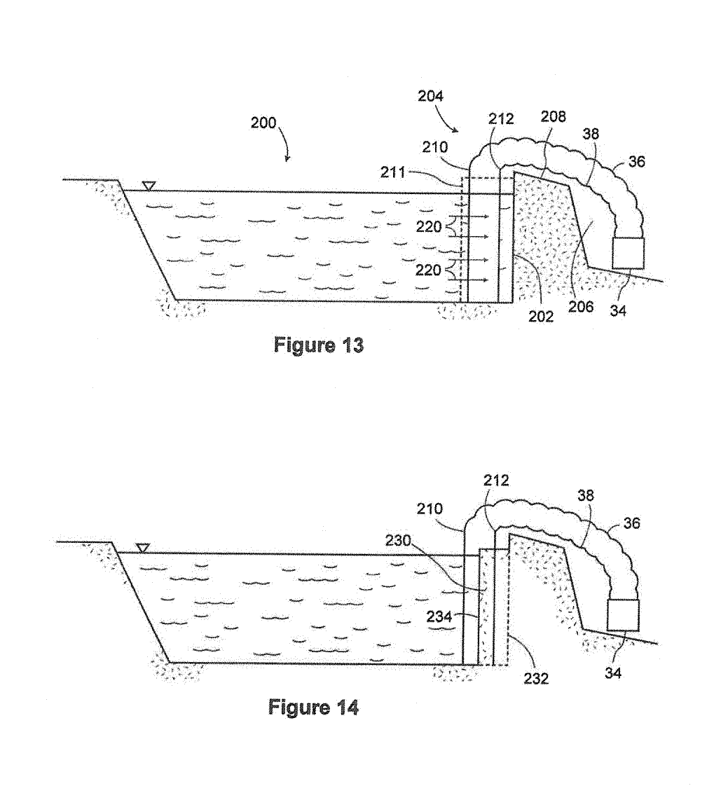

FIG. 13 shows a side wall of a containment structure 200 which has a more vertical face 202 on one side 204 than is desired and has suffered erosion or the like at 206 on the outside creating a potentially unstable and unsafe dike wall 208. It will be understood that erosion on the inside wall 202 is also comprehended.

According to the present invention the method of creating a geotechnical structure in a preferred location can be used to shore up or thicken walls of confinement structures such as dike walls by the application of the electro-treat to the tailings itself. For example, as shown in FIG. 13 the electrodes 210 (cathode), 212 (anode) can be placed adjacent a side of a containment structure wall 208 in a treatment volume 211, shown by dotted outlines, and the electro treat applied by the electrodes 38, 36 from the controller 34 in the same manner as described above. The treatment can be carried out for enough time to cause the solid particles to migrate to the anode 212 and to consolidate at the anode 212 as shown by the arrows 220. If enough time and energy is expended the anodes can become surrounded by a dewatered, dense or solid consolidation of tailings as shown in FIG. 14 as 230. As shown the old edge of the confinement wall was at dotted outline 232 but a new edge is at 234. Such a consolidation is a form of geotechnical structure which may help prevent the dike or sides of the containment structure from failing and thus may prolong the life of the containment structure while at the same time protecting the environment from unrestricted release of harmful pollutants within the tailings. The present invention therefore comprehends growing the wall thickness through the application of an electro treat to reinforce the side walls of a containment structure. In the preferred form the thickness is added to the inside part of the containment wall.

Various modifications and alterations are possible within the broad scope of the invention, some of which have been discussed above and other which will be apparent to those skilled in the art, for example the configuration of the frame electrode may vary and the amount and duration of the electro treat can also vary depending upon the end properties of the geotechnical structure that is desired. What is considered important is the realization that the electro treating of tailings can do more than dewater the tailings; it can be used to create desirable geotechnical structures where no such structures could previously be positioned. The techniques of the invention described above can also be combined, for example, a top layer can be formed and the side walls reinforced or a bottom layer made to prevent the top loading from expressing water through the sides and bottom of the pond, where that would be a risk based on the characteristics of the containment structure.

1. A method of electro treating tailings in a containment structure to cause a separation of at least some water from said tailings and a consolidation and compaction of at least some solid particles, said method comprising:
a. Placing a plurality of first electrodes in said tailings to be treated generally along one side of a predetermined volume;
b. Placing a plurality of second electrodes in said tailings to be treated generally along an opposite side of said volume to said plurality of first electrodes, said first and second electrodes being spaced apart by a predetermined distance;
c. Applying a treatment current across said distance between said spaced first and second electrodes to create an electrical field which causes solids to consolidate at one of said plurality of first and second electrodes; and
d. Creating a geotechnical structure within said volume comprised of dewatered solids consolidated from said tailings around one of said electrodes, the geotechnical structure forming a consolidated wall or layer adjacent to the containment structure to provide reinforcement.

2. The method of claim 1 wherein said geotechnical structure is one or more of a bottom generally horizontal layer within said containment structure and a side wall generally upright layer within said containment structure.

3. The method of claim 1 wherein said first and second electrodes are stationary during said treatment period.

4. The method of claim 1 wherein the electrical treatment consists of an AC current with a DC offset.

5. The method of claim 4 wherein the AC current consists of current in the range of 0.5 V/cm to 1.5 V/cm and the DC offset is an amount of 0.25 V/cm to 0.75 V/cm.

6. The method of claim 1 wherein said geotechnical structure has an average solids content of at least 50% solids.

7. The method of claim 5 wherein said electrodes are left in said geotechnical structure after the treatment is finished and act as reinforcements for said geotechnical structure.

8. The method of claim 2 wherein said layer is formed on a bottom of said containment structure and said lower electrodes are anodes.

9. The method of claim 2 further comprising creating a geotechnical structure forming a top generally horizontal layer formed on a top of said containment structure and said upper electrodes are anodes.

10. The method of claim 9 wherein said electrodes are formed into an electrode frame which is supported towards a top of said tailings within said containment structure.

11. The method of claim 10 wherein electrode frame is supported by means of one or more of floats, side anchors from outside of the containment structure and supports from below said electrode frame within the containment structure.

12. The method of claim 11 further including the installation of drains from below said frame.

13. The method of claim 12 further including the addition of a top load on said top layer to improve removal of water through said drains.

14. The method of claim 13 further including a pre-treatment step of forming geotechnical structures in the form of structures impervious to said fluid tailings layers, the formed impervious structures lining said containment structure through electro treating.

15. The method of claim 2 wherein said side wall generally upright layer is formed on an inside of said containment structure.

16. The method of claim 8 wherein said side wall layer is consolidated to the point of being generally impervious to the tailings fluid.

17. The method of claim 8 wherein said electrodes are discarded and remain as vertical reinforcing elements in said side wall layer.

18. A method of electro treating oil sands tailings to cause a separation of at least some water from said tailings and a consolidation and compaction of the remaining solid material, said method comprising:
a. Placing a plurality of first generally horizontal electrodes in said tailings to be treated;
b. Placing a plurality of second generally horizontal electrodes in said tailings to be treated in a position either generally above or generally below said first generally horizontal electrode, said electrodes being spaced apart by a predetermined distance;
c. Applying a treatment current across said distance between said spaced electrodes in a direction to cause a lower electrode of said electrode pair to be an anode and a higher of said electrode pair to be a cathode;
Wherein said electrical current urges solids to migrate in the same direction as gravity while water will migrate toward the cathode, allowing water to collect at the top of the treatment area.

19. The method of claim 18 wherein said generally horizontal electrodes are stationary during a treatment period.

20. The method of claim 18 wherein said generally horizontal electrodes are made from used pipe, tubing, cable, or any other conductive material suitable for electrical current transmission.

21. The method of claim 18 wherein said generally horizontal electrodes are part of a frame apparatus to be placed in a tailings treatment area.

22. The method of claim 21 where the frame apparatus also includes one or more vertically oriented spacer electrodes.

23. The method of claim 18 wherein said method includes the step of accumulating solids at said lower electrodes in said electrode pairs and then abandoning said lower electrodes in said accumulated solids.

24. The method of claim 23 wherein said method further includes the step of stopping to apply said electrical current and then placing further electrodes in said tailings at a position generally above said upper electrodes of said first electrode pairs to act as cathodes, and connecting the electrical current to the electrodes so that those originally used as cathodes serve as anodes.

25. The method of claim 24 wherein said method further comprises the step of applying a treatment current between said new electrode pairs and said electrical current urges said solids to migrate in a same direction as gravity thereby accumulating said solids towards the lower electrodes of said new electrode pairs.

26. The method of claim 18 wherein the water separated from the treated tailings collects at the top and is left in place to form a water cap over the treated tailings.

27. The method of claim 18 wherein the water separated from the treated tailings collects at the top and is removed by a pump so that the separated water can be re-used in a main extraction process.

28. The method of claim 18 wherein the cathode is a perforated pipe that allows water to collect in the pipe and be pumped out for re-use in the bitumen extraction process.

29. The method of claim 18, wherein said tailings are treated in discrete layers each one on top of the others.

30. The method of claim 18, wherein new tailings material is added to the treatment cell periodically as the existing tailings are treated and water is removed.
